(19) United States
(12) Patent Application Publication
(10) Pub. No.: US 2011/0215549 A1
(43) Pub. Date: Sep. 8, 2011

(54) HANDLEBAR EXTENSIONS

(76) Inventor: Richard Plainfield, Portland, OR (US)

(21) Appl. No.: 13/042,392

(22) Filed: Mar. 7, 2011

Related U.S. Application Data
(60) Provisional application No. 61/310,784, filed on Mar. 5, 2010.

(51) Int. Cl. B62K 21/12; B23P 11/00

(52) U.S. Cl. 280/270; 74/551.8; 29/428

(57) ABSTRACT

Embodiments provide one or more handlebar extensions which may be removably mounted to a handlebar of a bicycle. The handlebar extensions may include a cylindrical member having a first end portion and a second end portion. The handlebar extensions may further include a coupling mechanism for releasably coupling the second end portion to the handlebar. The first end portion may extend above the handlebar and may be configured to be grasped by a rider of the bicycle. In various embodiments, the first end portion may be at least partially bent with respect to the second end portion.

### CROSS REFERENCE TO RELATED APPLICATIONS

The present application claims priority to U.S. Provisional Patent Application No. 61/310,784, filed Mar. 5, 2010, entitled “HANDLEBAR EXTENSION BARS,” the entire disclosure of which is hereby incorporated by reference in its entirety.

### TECHNICAL FIELD

Embodiments herein relate to the field of cycling, and, more specifically, to accessories for handlebars.

### BACKGROUND

Handlebars may be coupled to a forward portion of a frame of a bicycle and may be used for steering and/or controlling the bicycle. The handlebars may cause a rider to hunch forward considerably to grasp them while riding. This is especially true for “road” or “racing” bicycles, which typically have drop handlebars. Although a hunched over position may be aerodynamically advantageous if the rider is in a race, extended periods of being hunched over handlebars, such as might occur during a long-distance race, may cause the rider to experience considerable discomfort. For example, the rider's back may become sore or the rider's shoulders or hands may become fatigued from supporting the rider's upper body above the handlebars.

### BRIEF DESCRIPTION OF THE DRAWINGS

Embodiments will be readily understood by the following detailed description in conjunction with the accompanying drawings and the appended claims. Embodiments are illustrated by way of example and not by way of limitation in the figures of the accompanying drawings.

FIG. 1 illustrates a side view of a handlebar extension in accordance with various embodiments;

FIG. 2 illustrates a perspective view of handlebar extensions in accordance with various embodiments; and

FIG. 3 illustrates a front view of handlebar extensions in accordance with various embodiments.

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “NB” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous, and are generally intended as “open” terms (e.g., the term “including” should be interpreted as “including but not limited to,” the term “having” should be interpreted as “having at least,” the term “includes” should be interpreted as “includes but is not limited to,” etc.).

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

In various embodiments, methods, apparatuses, and systems for handlebar extensions are provided. One or more handlebar extensions may be removably mounted to handlebars of a bicycle, such as drop handlebars of road bicycles, to provide a rider with something to grab onto while the rider takes a break from a hunched over position. The handlebar extensions may allow the rider to control, steer and/or balance the bicycle.

The handlebar extensions may include a cylindrical member having a first end and a second end. The handlebar extensions may further include a coupling mechanism for releasably coupling the second end to the handlebar. The first end may extend above the handlebar and may be configured to be grasped by a rider of the bicycle. In various embodiments, the first end may be at least partially bent with respect to the second end.

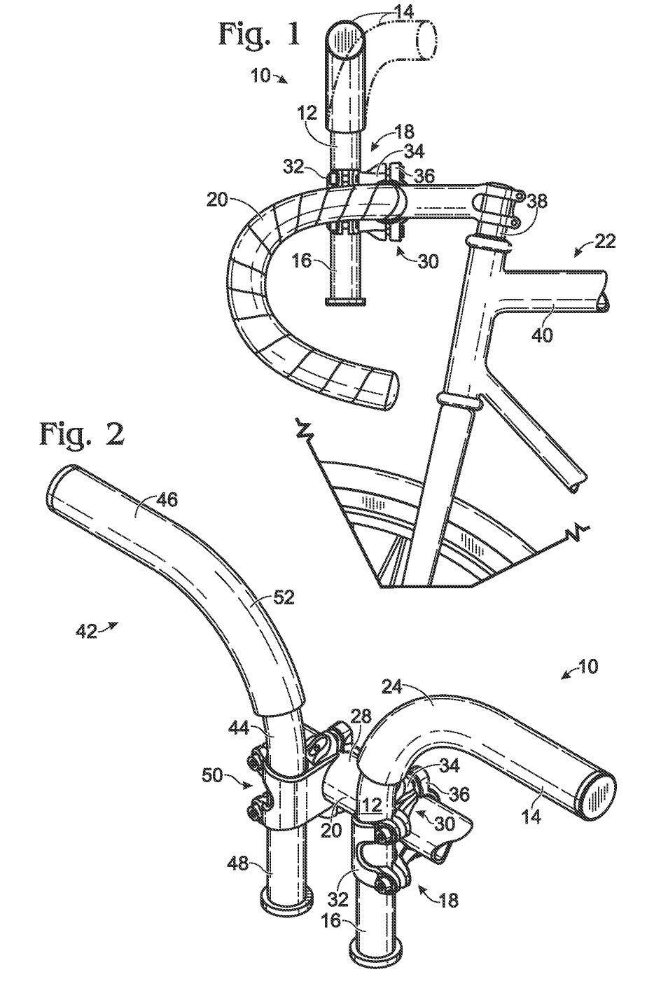

Referring to FIGS. 1-3, handlebar extension 10, also referred to herein as extension 10, may include a cylindrical member 12 having a first end 14 and a second end 16. In some embodiments, the first end 14 may be an upper end, and the second end 16 may be a lower end. The first end 14 may be configured to be grasped by a user. For example, in some embodiments, the first end 14 may include a grip, such as a rubberized grip.

Handlebar extension 10 may further include a coupling mechanism 18. The coupling mechanism 18 may be used to releasably couple the second end 16 to a handlebar 20 of a bicycle 22. When the second end 16 is coupled to the handlebar 20, the first end 14 of the cylindrical member 12 may extend above the handlebar 20. Accordingly, a rider may be able to sit more upright while grasping the first end 14 than when grasping the handlebar 20.

In various embodiments, the cylindrical member 12 may include a bend 24 so that first end 14 is oriented at an angle 26 with respect to the second end 16. For example, the first end 14 and second end 16 may each be substantially straight, and the cylindrical member may include a bend 24 between the first end 14 and the second end 16. In some embodiments, the angle 26 may be between about 70 degrees and 110 degrees, although other angles are possible. In exemplary embodiments, the angle 26 may be about 90 degrees.

Accordingly, the second end 16 may be substantially vertical when coupled to the handlebar 20, and the first end 14 may be substantially parallel to a horizontal portion 28 of the handlebar 20. Similarly, in some embodiments, the first end 14 may be substantially coplanar with the horizontal portion 28 of the handlebar 20 so that the first end 14 is disposed above the handlebar 20. In other embodiments, the first end 14 may extend partially inward (e.g., toward the rider), as shown by the dashed lines of FIG. 1.

In various embodiments, any suitable coupling mechanism 18 may be used to couple the second end 16 of the cylindrical member 12 to the handlebar 20. For example, the coupling mechanism 18 may include a first clamp 30 that couples the coupling mechanism 18 to the handlebar 20, and a second clamp 32 that couples the coupling mechanism 18 to the second end 16.

In some embodiments, the first clamp 30 may include a first bracket 34 and a second bracket 36 coupled around the handlebar 20. The first bracket 34 and second bracket 36 may be coupled together by one or more screws, nuts, and/or another mechanism. The second clamp 32 may be a circular clamp having an open circular shape that may be closed and tightened around the second end 16 of cylindrical member 12 by a screw, nut, and/or another mechanism. In other embodiments, the first clamp and/or second clamp may be any suitable clamp, such as brackets, a circular clamp, and/or another suitable clamp. In some embodiments, the second clamp 32 may be coupled to the cylindrical member 12 with an adhesive, such as glue.

In some embodiments, the second clamp 32 may be integrated with the first clamp 30. In other words, the second clamp 32 and first clamp 30 may be part of the same construction. In embodiments where the first clamp 30 includes the first bracket 34 and second bracket 36, the second clamp 32 may be coupled with at least one of the first bracket 34 and the second bracket 36. In some embodiments, the first clamp 30 may be integrated into the cylindrical member 12. In these embodiments, a second clamp 32 may not be included.

In some embodiments, the first clamp 30 may couple the second end 16 to the horizontal portion 28 of the handlebar 20. In these embodiments, the first clamp 30 may be substantially perpendicular to the second clamp 32, so that the first clamp 30 may couple the second end 16 to the horizontal portion 28 of the handlebar 20 and orient the second end 16 substantially vertically. In other embodiments, the first clamp 30 may be coupled to another portion of the handlebar 20, such as a stem 38 (i.e., steering post) of the handlebar 20, and/or another part of the bicycle such as a frame 40.

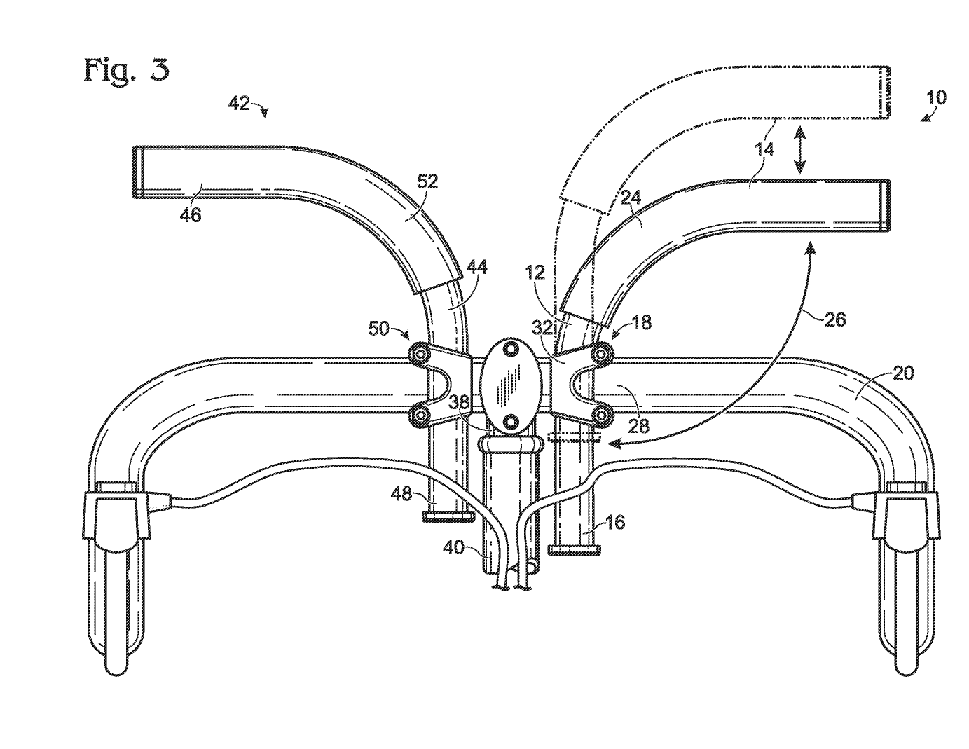

In some embodiments, the second clamp 32 may allow the cylindrical member 12 to rotate within second clamp 32, as depicted by the dashed lines in FIG. 1. Similarly, the second clamp 32 may allow the cylindrical member 12 to move up and/or down with respect to second clamp 32, as depicted by the dashed lines in FIG. 3. This movement may allow the rider to adjust the position and/or orientation of the first end 14.

In various embodiments, a second handlebar extension 42 may be coupled to the handlebar 20 of the bicycle in addition to the first handlebar extension 10. The first handlebar extension 10 may be coupled to the left or right side of the handlebar 20, e.g., on the left or right side of the stem. The first end 14 of the first handlebar extension 10 may extend outwardly (i.e., away from the stem 38) over the handlebar 20.

The second handlebar extension 42 may be coupled to the other side of the handlebar 20 from the first handlebar extension 10. The second handlebar extension 42 may be a mirror image of the first handlebar extension 10, so that it extends outwardly in the opposite direction from the first handlebar extension 10. The first and second handlebar extensions 42 may provide locations for the rider to grasp with first and second hands, respectively, while sitting upright.

Second handlebar extension 42 may include a cylindrical member 44 having a first end 46 and a second end 48. Second end 48 may be coupled to handlebar 20 by a coupling mechanism 50. First end 46 may be configured to be grasped by a rider. In some embodiments, the cylindrical member 44 may include a bend 52 between the first end 46 and the second end 48.

Various shapes of handlebar extensions may be provided. For example, the handlebar extension may be shaped substantially similar to a “T” or a “Y.” In these embodiments, the first end of the handlebar extension may extend both to the left and to the right from the second end. The user may grasp one or both sides of the first end when riding the bike.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

What is claimed is:

1. A handlebar extension, comprising:
a cylindrical member having a first end and a second end, the first end configured to be grasped by a user;
a coupling mechanism configured to be releasably coupled to the second end and configured to be releasably coupled to the handlebar so that the first end of the cylindrical member extends above the handlebar.

2. The handlebar extension of claim 1 wherein the cylindrical member includes a bend so that the first end of the cylindrical member is oriented at an angle relative to the second end of the cylindrical member.

3. The handlebar extension of claim 2 wherein the second end of the cylindrical member is substantially vertical when coupled to the handlebar, and the first end of the cylindrical member is oriented at an angle of about 90 degrees relative to the first member.

4. The handlebar extension of claim 3 wherein the first end of the cylindrical member is substantially parallel with a horizontal portion of the handlebar.

5. The handlebar extension of claim 1 wherein the coupling mechanism comprises a first clamp to couple the coupling mechanism to a horizontal portion of the handlebar and a second clamp configured to couple the coupling mechanism to the cylindrical member, the second clamp oriented substantially perpendicular to the first clamp.

6. The handlebar extension of claim 1 wherein the coupling mechanism is configured to couple with a vertical portion of the handlebar.

7. The handlebar extension of claim 1 wherein the cylindrical member comprises a first cylindrical member, and the handlebar extension further comprises a second cylindrical member, the second cylindrical member being a mirror image of the first cylindrical member.

8. A bicycle assembly comprising:
a bicycle having a frame and a handlebar coupled to the frame;
at least one handlebar extension coupled to the handlebar, the handlebar extension including:
a cylindrical member having an upper end and a lower end, the upper end configured to be grasped by a user; and
a coupling mechanism releasably coupled to the lower end and releasably coupled to the handlebar so that the upper end of the cylindrical member extends above the handlebar.

9. The bicycle of claim 8 wherein the cylindrical member includes a bend so that the upper end of the cylindrical member is oriented at an angle relative to the lower end of the cylindrical member.

10. The bicycle of claim 9 wherein the lower end of the cylindrical member is substantially vertical when releasably coupled to the handlebar, and the upper end of the cylindrical member is oriented at an angle of between 70 degrees and 110 degrees relative to the lower member.

11. The bicycle of claim 10 wherein the upper end of the cylindrical member is substantially parallel with a horizontal portion of the handlebar.

12. The bicycle of claim 8 wherein the coupling mechanism comprises an integral first clamp and an integral second clamp, the first clamp coupling the coupling mechanism to a horizontal portion of the handlebar and the second clamp coupling the coupling mechanism to the cylindrical member, the second clamp oriented substantially perpendicular to the first clamp.

13. The bicycle of claim 8 wherein the coupling mechanism is coupled to a vertical portion of the handlebar.

14. The bicycle of claim 8 wherein the one or more handlebar extensions include a first handlebar extension and a second handlebar extension, wherein the first and second handlebar extensions are oriented opposite one another on opposite sides of a stem of the handlebar.

15. A method, comprising:
coupling a first bracket of a first coupling mechanism to a handlebar; and
coupling a second bracket of the first coupling mechanism to a lower end of a cylindrical member that includes an upper end at least partially bent with respect to the lower end, the upper end being configured to be grasped by a first hand of a rider.

16. The method of claim 15, further comprising:
coupling a third bracket of a second coupling mechanism to the handlebar at a position opposite a stem of the handlebar from the first coupling mechanism; and
coupling a fourth bracket of the second coupling mechanism to a second lower end of a second cylindrical member that includes a second upper end at least partially bent with respect to the second lower end, the second upper end being configured to be grasped by a second hand of the rider.
